(19) United States
(12) Patent Application Publication
(10) Pub. No.: US 2023/0063322 A1
(43) Pub. Date: Mar. 2, 2023

(54) METHOD FOR OPERATING A DISCHARGE LAMP AND DISCHARGE LAMP

(71) Applicant: OSRAM GmbH, München (DE)

(72) Inventors: Bernd KOCH, Niedergörsdorf (DE); Michael HEISE, Berlin (DE); Sascha PILTZ, Berlin (DE); Kai WOLTER, Berlin (DE)

(21) Appl. No.: 17/898,586

(22) Filed: Aug. 30, 2022

(30) Foreign Application Priority Data
Aug. 31, 2021 (DE) 10 2021 209 559.3

(51) Int. Cl. G03B 21/20; H05B 41/292; H05B 41/39

(52) U.S. Cl. CPC G03B 21/2053; G03B 21/2026; H05B 41/2928; H05B 41/39

(57) ABSTRACT

The invention describes a method for operating a discharge lamp by adapting a current signal. A distribution function is defined for gathering several time span values that define several different time spans. The several time span values are determined depending on the distribution function by one or more random numbers. The current signal is commutated at every instant of time according to an expiry of each of the several time spans. A light apparatus is provided with a control unit to perform any method.

### CROSS-REFERENCE TO RELATED APPLICATION

This application claims priority to German Patent Application No. 10 2021 209 559.3, filed on Aug. 31, 2021. The aforementioned application is hereby incorporated by reference in its entirety.

### DESCRIPTION

The current invention relates to a method for operating a discharge lamp by adapting a current signal. The invention also relates to a discharge lamp comprising an arc tube with a pair of electrodes and a control unit. The control unit can control and/or adapt the current signal or current flow.

Discharge lamps are often operated with a rectangular current wave form of alternating polarity. The operation frequency of the current is known to have a major impact on the shaping of the electrode tips of the discharge lamp and therefore on the lifetime and overall behavior of the discharge lamp. A continuous operation of a discharge lamp with a single frequency is often insufficient to reach an extended lifetime. At the same time, the operation frequency of the current causes other effects that should be considered, for example acoustical noise, visible light fluctuations or an interference with the operation of imaging sensors used in television or mobile phone cameras. A general approach is to apply a phase or frequency modulation scheme. Different operation frequencies may be applied to the discharge lamp.

For example, European Patent Specification EP 1 624 733 B1 describes a device for operation of a high-pressure discharge lamp that comprises a discharge vessel made of silica glass in which there is a pair of opposed electrodes. A feed device is adapted to supply an alternating current to the discharge lamp. An alternating current can be applied within the range from 60 Hz to 1000 Hz as a stationary operating frequency. A low frequency can be inserted into the alternating current of the stationary operating frequency. The low frequency is lower than the stationary frequency and is in a range from 5 Hz to 200 Hz.

The invention is based on the knowledge that a regular current signal may lead to drawbacks in operating discharge lamps. The current signal or current flow in a discharge lamp should not be completely deterministic, but at least influenced by some degree of randomness.

A task of this invention may be to offer a method for operating a discharge lamp so that quality and/or the lifetime of the discharge lamp can be increased.

This task can be solved by the independent claims of this application. Advantages and alternative embodiments are described in the dependent claims, in the description as well as in the figures.

A first aspect of this invention relates to a method for operating a discharge lamp by adapting a current signal. The method comprises the following steps. In a first step, a distribution function is defined and/or provided for gathering several time span values that define several different time spans. The time span values may be expressed by several different numerical values. These numerical values that represent the time span values preferably indicate how long a duration of the time span is. This means that different time span values may define several time spans. A time span may be considered as a time interval. The time span values or the corresponding numerical values can define a duration of milliseconds. For example, the time span values 5, 10 and 6 define three different time spans. The first time span has a duration of 5 ms, the second time span has a duration of 10 ms, and the third time span has a duration of 6 ms. Preferably, the several time spans or time intervals are arranged directly consecutively. This may mean that between two time spans, there is no temporal gap. Several time span values may be expressed in the form of a set or array that contains several time span values.

In a next step, the several time span values are determined depending on the distribution function by one or more random numbers. Although the time span values are influenced by the distribution function, a determination of the time span values is not completely deterministic since the time span values are influenced by at least one random number. The random number or random numbers may be generated by a genuine random number generator, a pseudo random number generator or by application of a low discrepancy series. A statistical method like the inversion method can be applied to calculate the time span values from the random numbers according to a prescribed distribution function. The random number may be applied to the distribution function in order to obtain the time span value or values. The several time span values may be distributed according to this distribution function.

The expressions “first” and “second” preferably do not contain any specific technical content. These two different expressions, “first” and “second”, are preferably only to be considered as names allowing to distinguish between the different frequencies.

The inversion method relies on the principle that continuous cumulative distribution functions range uniformly over the open interval (0,1). If u is a uniform random number on (0,1), then x=F⁻¹(u) generates a random number x from any continuous distribution with the specified cumulative distribution function F. F⁻¹ may be regarded as the inverse function in this case. Sometimes this approach is called “Inverse Transform Sampling”.

In a next step, the current signal is commutated at every instant of time according to an expiry of each of the several time spans. The term “commutate” may be considered as a switch of the polarity. Discharge lamps are usually operated by using an alternating current. According to this method, also an alternating current is applied but the time spans are different and furthermore are determined randomly due to the random number(s). The current signal of the lamp current can be constructed as a continuous stream of time spans of direct current separated by the change of current direction (commutation). Preferably the current is constant within the time span. In particular at a following time span the change in polarity is realized by commutation. The time spans or their duration may have a profound influence on a shaping of electrode tips of the discharge lamp. Therefore, the discharge lamp lifetime can be increased. Preferably, the duration of each consecutive time span is chosen randomly, wherein in particular no relation to a preceding or succeeding time span is present. The current signal of the discharge lamp may be solely controlled by a distribution function and the at least one random number. Alternatively, a certain predetermined correlation of the random numbers may be forced. The predetermined correlation can lead to an averaged current over a pregiven time-interval. The current is preferably zero averaged over said time-interval. An example of this would be a balance of time spans with positive and negative current polarity averaged over a time interval comprising several time spans. Another correlations may be possible. An uneven or irregular load of the discharge lamp or electrode tips can be avoided.

The current signal may be regarded as a current flow. All explanations that are presented for the current signal or current flow can be extended to a voltage signal. Preferably the current signal refers to the current.

According to an advantageous additional or alternative embodiment, the several time spans are arranged directly adjacent. The operation of the discharge lamp may be defined by the several time spans. Preferably, no temporal gap appears between two time spans. This means that after a first time span, instantly a second time span may follow. This may result in a more random current signal for the operation of the discharge lamp.

According to an advantageous additional or alternative embodiment, several distribution functions are used and for each time span value one of those distribution functions is selected according to a further random number. The further random number can be another additional random number. The further random number can influence the selected distribution function. This means by a method for determining the further random number each distribution function may have its own probability to be selected. This offers the possibility to adapt a likelihood or probability of selecting the distribution function. This can be achieved by the determining or calculating the further random number. Alternatively, several distribution functions can be superposed to the distribution function. Such a superposed distribution function can be used for determining the several time span values.

For example, a uniform distribution function and a Gaussian distribution function may be different distribution functions. The superposition may be implemented by a simple addition of the original distribution functions using predetermined weighting factors. The weighting factors can influence an impact of the distribution function on determining the time span values. An appearance of certain time span values may be stimulated or suppressed.

Alternatively, an additional further random figure may be used to select one of the several distribution functions. For example, if two different distributions functions are available and should occur with a probability of 30% for the first and 70% for the second distribution, an additional random figure R may be randomly chosen out of the interval 0 to 1 and if 0≤R<0.3, the first distribution is selected, otherwise the second. By adapting the interval for R, here 0 to 0.3 the application of the first distribution function may be further supported or suppressed.

According to an advantageous additional or alternative embodiment, the step of defining a distribution function, the step of determining the several time span values and/or the step of commutating the current signal are performed repeatedly. This means that a plurality of time span values and time spans may be determined and/or created. Since the time span values are depending on the at least one random number, it can be ensured that always some degree of randomness is present.

According to an advantageous additional or alternative embodiment, the distribution function is defined depending on one or more discharge lamp parameters and/or an environmental parameter with regard to the discharge lamp. The discharge lamp parameters may be a lamp voltage, a power level of the discharge lamp, a position and orientation of the discharge lamp, a current flow through the discharge lamp and/or an abrasion degree of a pair of electrode tips. Furthermore discharge lamp parameters may be an average lamp voltage, a property or condition of the electrode tips, operating hours of the discharge lamp and/or a voltage ratio of times spans of opposite polarity. The physical impacts on the discharge lamp may be considered by the distribution function. The distribution function may be a function with a given distribution. This may be a uniform distribution, a Gaussian distribution, an overlay distribution, an exponential distribution, a power law distribution or any other distribution. Additionally, all mentioned discharge lamp parameters, such as the inclination of the discharge lamp may be considered additionally.

The parameters may be gathered by appropriate sensors. The voltage may be measured by a voltage sensor, the current by a current sensor. The same is valid for any other parameter which may be gathered or measured by appropriate sensors. The data of the sensors can be transmitted to a control unit that is configured to operate the discharge lamp. The control unit is able to conduct or perform any methods or examples mentioned herein if the control unit is activated.

Additionally, this embodiment allows to consider one or more discharge lamp parameters via the distribution function. It is also possible to consider a form or shape of the electrode tips. If a thickness or size of the electrode tips is below a pre-given threshold value, the time span values may be adapted in a way that the resulting current signal follows a frequency range that is gentle or mild on the electrode tips. The distribution function may be chosen or modified dynamically based on the discharge lamp parameters. The lamp parameters may characterize the conditions of the electrodes. Such parameters may be the average lamp voltage, the lamp voltage depending on the current direction, or the dynamic behavior of the lamp voltage during a segment length.

In a further additional or alternative embodiment, several time spans define a pattern or building block. Each pattern can comprise two or more time spans with fixed duration ratios. A total duration of each pattern may be determined randomly depending on one or more distribution functions and at least one random number. A further variation can be introduced by an accidental pattern that can be selected from a plurality of patterns. This means that several patterns are present and with an appropriate random number, one of the several patterns may be chosen or selected. The selected pattern may be used to determine the several time span values. According to the time span values, the commutation is carried out at every instant of time according to the expiry of each of the several time spans. This allows to consider certain boundary conditions and nevertheless, the random character of the current signal may remain. Additionally, discharge lamp parameters may also be considered in the patterns.

According to an advantageous additional or alternative embodiment, the distribution function is defined dynamically based on a measured quantity or several measured quantities that describe the lamp parameter and/or the parameter of the pair of electrodes of the discharge lamp. For example, the distribution function may consider a condition, lifetime or wear of the electrode tips. Additionally, the lamp voltage can be considered by all distribution functions. In this context, it is also possible to consider a dynamic behavior of the lamp voltage during one or more time spans. It is possible that the lamp voltage is described and/or represented by a characteristic diagram. Therefore, it is possible to consider lamp parameters and nevertheless the resulting current signal for the operation can be kept random.

According to an advantageous additional or alternative embodiment, a separate distribution function can be defined for different types of discharge lamps and/or for different groups of discharge lamps. This means that the distribution function may be individual for the different types or groups of discharge lamps. For example discharge lamps in different rooms may be assigned to different groups. Different types of discharge lamps can arise due to different filling gases for the discharge lamps. Discharge lamps with filling gas Argon can be interpreted as a different type than discharge lamps with Helium, Krypton etc. as filling gas. Discharge lamps with different ranges with regard to an operating or working voltage can be considered as different group or type of discharge lamps. Preferably, each type or group of discharge lamp can be related to a certain distribution function.

According to an advantageous additional or alternative embodiment, the distribution function is defined as a probability density function with a corresponding cumulated density function and the several time span values are determined by applying the one or more random numbers to a corresponding inverse function of the cumulated density function. This embodiment offers a certain method to determine or evaluate one or more time span values by the use of one or more random numbers. The distribution function may be defined or transformed to a probability density function. Depending on the probability density function, a corresponding cumulated density function may be defined and/or formulated. Preferably, the cumulated density function is invertible. This means that the cumulated density function may be monotonously increasing or decreasing. Preferably, the cumulated density function is strictly increasing or strictly decreasing. This may ensure that the cumulated density function is invertible. If the one or more random numbers are put into the inverse function, the one or more time span values can be calculated. This method can be called an inversion method. It is possible to use or apply other statistical methods in order to calculate numerical values for the time spans. Since the inversion method is a known method, it can be conducted by a random number generator.

According to an advantageous additional or alternative embodiment, the defining of the distribution function is based on a dynamical behavior of the average lamp voltage, a dynamic behavior of the lamp voltage during each time span and/or a dynamical behavior of the current flow through the discharge lamp. Additionally, a dynamical behavior of all mentioned discharge lamp parameters may be considered additionally.

According to an advantageous additional or alternative embodiment, several distribution functions are given and the distribution function for determining the time span values is selected based on a threshold value concerning the discharge lamp voltage. In this embodiment, a single distribution function can be selected from several different distribution functions. The selection of the distribution function is depending on the threshold value of the discharge lamp voltage. Since different ranges of lamp voltage can result into different wear or tear of the electrode tips, the several distribution functions can relate to or address different frequency ranges of the current. A lamp voltage above or below the threshold value may indicate a certain status of the discharge lamp or the electrode tips.

If a certain status is detected, it is possible to apply another different distribution function that relates to another frequency range concerning the current that is rather suitable for an improved operation of the discharge lamp. For example, if the lamp voltage falls below 60 volts, a change of the applied distribution function may be initiated. This means that another distribution function is used to determine the time span values and therefore to configure the current for a current signal in a different manner according to the time span values that are determined according to another distribution function.

According to an advantageous additional or alternative embodiment, at least two different probability functions are given and a distribution function for determining the time span values is a superposition of the at least two different probability functions, wherein the superposition is depending on the lamp voltage. The probability function may be called as initial function. The superposition may depend on the lamp voltage. Each initial function may relate to a certain condition or status of the discharge lamp. For example, a first initial function may be appropriate for a discharge lamp with electrode tips that do not show a significant degree of wear and tear. A second initial function may be appropriate if a certain degree of wear and tear has appeared at the electrode tips of the discharge lamp. It is possible to evaluate the degree of wear and tear of the electrode tips depending on the lamp voltage. This means that the lamp voltage allows to evaluate the information about the degree of wear and tear of the electrode tips. If a discharge lamp shows a status in between two pre-given conditions, a mixture of the different initial functions may lead to an improved distribution function for the operation of the discharge lamp. The initial functions may be considered as probability distributions.

According to an advantageous additional or alternative embodiment, the distribution function is defined by a characteristic diagram of the discharge lamp voltage. In particular, the distribution function depends on a threshold value of the discharge lamp voltage. The characteristic diagram may be a table, look-up table and/or a predetermined characteristic curve valid for the discharge lamp. In this context it is possible to analyze the lamp voltage with regard to the characteristic diagram. For example a correlation may be used. The correlation may define the distribution function. The above-mentioned advantages and examples are also valid for this embodiment.

According to an advantageous additional or alternative embodiment, the distribution function may contain a boundary condition. For example a certain range of time span values for the current signal can be provided as boundary condition. This preferably leads to corresponding time span values. For example, the boundary condition may contain a time span interval from 0,625 ms to 20 ms. This would lead to corresponding time span values. Of course other values concerning the limits for the time span values are possible.

According to an advantageous additional or alternative embodiment, a probability value with regard to a corresponding predetermined time span value is defined by the boundary condition or several probability values with regard to corresponding predetermined several time span values are defined by the boundary condition. This may include that a probability value concerning the time span values can depend on an upper limit and/or lower limit for the time spans. The upper limit can define a maximum time span value and the lower limit can define a minimum time span value. In particular the probability ratio at the several time span values can be defined by a minimum and/or a maximum ratio to each other. It is also possible that the probabilities of the several time span values can be defined by a ratio to each other. The lower limit and upper limit can be defined for possible time span values by the distribution function. In this context, a ratio of the probability density at the values for the upper and lower limit (i.e. points T1 and T2) can be specified. For example a power distribution function as specified herein as a formula is completely defined.

The distribution function can influence the probability values for the predetermined time span values. By means of the distribution function the likelihood or probability of the time span values can be adapted or influenced. This can be achieved by an appropriate mathematical adaption of the distribution function. Such an adaption can be considered as the boundary condition. In particular, a maximum and a minimum value can be defined by the boundary condition. The boundary condition may comprise a predetermined selection of certain time span values that may have a higher probability to be applied for the lamp operation. It is possible that certain predetermined time span values are completely excluded by the boundary condition. By means of the boundary condition the factor “randomness” can be weakened and replaced by a little bit deterministic influence.

The two or more time span values may be combined in a pattern or building block. That means the pattern can comprise two or more time span values and therefore two or more time spans. In this case, the randomness may be limited to required circumstances for the operation of the discharge lamp. Such circumstances may arise because of an abnormal wear and tear of the discharge lamp or the electrode tips of it. Especially the lamp voltage can give an indication or information about such circumstances or the status of the discharge lamp.

The building blocks can define a single time span or time span value for the current signal. In this case the current signal may be assembled by several building blocks, wherein each building block can define another time span or time span value. The assembling of several building blocks can be depending on pre-given rules. Such rule may contain a certain pre-given sequence of equal and/or different building blocks. For example two building blocks with the same time span are assembled and after that another two building block with different time spans are used. Alternatively, between two building blocks with the same time span, another different third building block with a different time span may be inserted. The resulting current signal can be sequence of different building blocks. The building blocks may be selected randomly by use of the random number. Additionally, the time span values can be determined by the one or more random number. The term “building block” can be interpreted as a mathematical function that is used as distribution function or to assemble a distribution function.

Preferably the time span values are not determined individually. The boundary condition preferably relates to directly adjacent time spans. This means that a following time span can be completely determined independently of the preceding time span. Nevertheless, a group of time spans, which can be regarded as the pattern, can be determined independently of each other. The pattern can comprise a large number of time spans or time span values. For example, a pattern can comprise 100 to 1000 time spans. Additionally, a total duration of a pattern can be determined randomly according to all mentioned and explained methods according to this application. The current flow or current signal for a discharge lamp operation may be adapted to certain requirements and additionally a useful degree of randomness may be contained.

According to an advantageous additional or alternative embodiment, the distribution function is superposed with a predetermined function. Alternatively, the distribution function can be superposed with several predetermined functions or one of several predetermined functions, wherein at least one of the several predetermined functions is selected by the at least one random number. In this embodiment, the random number is used for two purposes. On the one hand, the random number can be used to select one of the predetermined functions superimposed with the distribution function. On the other hand, the at least one random number can also be used to determine the time span values for the current signal or current flow. Alternatively, for each purpose, a separate random number can be used. This means a first random number can be used to select one of the several predetermined functions that is superposed with the distribution function and a second random number can be used to determine the time span values. Of course, different second random numbers or a set of several different random numbers may be used to determine several time span values. Additionally, discharge lamp parameters like the lamp voltage may also be considered in this embodiment. A comparison of a measured lamp voltage with the threshold voltage value can influence the superposition and/or the selection of one of the several predetermined functions. Depending on the lamp voltage a different function or different several functions can be chosen for the superposition. A voltage value above the threshold value can lead to a different superposition compared to a voltage value below the threshold value.

According to an advantageous additional or alternative embodiment, the distribution function may also be defined by or depend on a lifetime of the discharge lamp. The lifetime of the discharge lamp may be an estimated time the discharge lamp may exist. In particular, this time considers a burning time of the discharge lamp. The burning time is often indicated by a value in units of hours. The lifetime may also consider an elapsed time since the production of the discharge lamp. In these cases, the operation of the discharge lamp may be adapted more individually to the corresponding discharge lamp and additionally enough degree of randomness is present during the discharge lamp operation to ensure that the current signal is not completely deterministic.

According to an advantageous additional or alternative embodiment, a current signal or a current flow is a wave-shaped signal, a square-wave signal or a mixture or wave-shaped and square-shaped signal. Preferably the current signal is a square-wave signal. It is possible that different distribution functions relate to different types of signals. For example, a first distribution function may relate to a wave-shaped signal and another second distribution function may relate to a square-wave signal. A third distribution function may relate to a mixture of wave-shaped and square-wave signal. According to the selected distribution function, also the signal form may be changed by a random influence due to a random selection of the distribution function.

A further evaluation of the invention may be created if a part of a function that may be considered as basic function is used to create a randomized current flow or current signal. The basic function may be considered as a rule. The basic function or rule is rather a norm for the creation of the current signal for the discharge lamp operation. Such rule may comprise a change of the polarity or performance of a commutation if a boundary condition or predetermined condition is fulfilled. Such boundary condition or predetermined condition may be a lamp voltage over or below a threshold value concerning the lamp voltage, a temperature, a pressure within the discharge lamp, etc.

According to an advantageous additional or alternative embodiment, the distribution function is defined as a uniform distribution, a normal distribution an exponential distribution, a power law distribution and/or an overlaid normal distribution. Additionally, the distribution function may be defined according to a rule for operating the discharge lamp. The above-mentioned advantages and examples are also valid for this embodiment.

A second aspect of this invention addresses a lighting apparatus. The lighting apparatus comprises a discharge lamp which comprises with an arc tube. The arc tube can comprise a pair of electrodes. Preferably, the current signal or current flows across this pair of electrodes. Due to this current flow across the pair of electrodes, an arc appears within the discharge lamp. The current flow may be considered as a flow of charge carriers. The arc in the arc tube of the discharge lamp results in light emission of the discharge lamp.

The lighting apparatus can comprise one or more sensors. A voltage and/or current sensor is able to measure a lamp voltage and/or a current flow through the discharge lamp. The lighting apparatus can comprise a ballast unit. The ballast unit can provide a current signal for the discharge lamp. The sensor or current sensor can be preferably located at or in the ballast unit. The ballast unit can include the control unit. In particular the sensor to measure the lamp voltage and/or current can be a microprocessor. The lighting apparatus can comprise a light sensor to measure a lumen emitted by the discharge lamp. All sensors may be arranged in the ballast unit.

The lighting apparatus can comprise a control unit. The control unit may gather data from the sensors to perform any methods that rely on sensor data. A current detector and/or voltage detector are possible sensors. Light sensors, current sensors, voltage sensors or any other type of sensor that is needed to perform one of the mentioned methods can be part of the discharge lamp.

Within the arc tube, a filling gas may be present. The filling gas may be a noble gas or a metallic gas. Vaporized mercury may be a metallic gas, for example. The discharge lamp comprises a control unit. This control unit is capable of conducting all explained methods and examples within this application. Preferably, the control can define the distribution function for gathering several time span values. The control unit may also determine the several time span values depending on the distribution function by one or more random numbers. In particular, the control unit contains a random number generator and is able to provide one or more random numbers. The control unit is able to control the current signal. In particular, the control unit can commutate the current signal. The current signal may be commutated by the control unit at every instant of time according to an expiry of each of the several time spans. The control unit is capable and configured to conduct any of the methods described or explained within this application.

The features, examples and advantages presented in connection with the method according to the first aspect of the invention apply mutatis mutandis to the discharge lamp according to the second aspect of the invention, and vice versa. This means that features of the method can be considered to be features of the discharge lamp. Inversely, features of the discharge lamp may be considered to be features of the method for operating the discharge lamp.

The control unit may comprise one or more microprocessors and/or one or more microcontrollers. Further, the control unit may comprise program code that is designed to perform any method described herein when executed by the control unit. The program code may be stored in a data storage of the control unit.

The control unit can comprise a processor adapted to perform the method of any embodiment or example mentioned in this application. The control unit can be realized by a computer program product or a discharge lamp with the control unit comprising instructions which, when the program is executed by a computer or the control unit, cause the control unit or computer to carry out any steps of all embodiments or methods mentioned within this application. The computer program product can comprise instructions which, when the program is executed by the control unit or the computer, cause the control unit to carry out or execute the steps of any embodiment mentioned in this application.

It is possible that the invention provides a computer program product. The computer program product can comprise instructions to cause the discharge lamp to execute the steps of all embodiments or methods mentioned in this application. Furthermore a computer-readable medium having stored thereon the computer program product can be part of this invention.

The invention is explained by the following figures. It should be considered that all figures and their explanations shall only indicate some possible embodiments and possibilities to conduct the invention. In no case, the figures should be interpreted in a way that the examples described herein limit the scope of this invention.

In this context the figures show in:

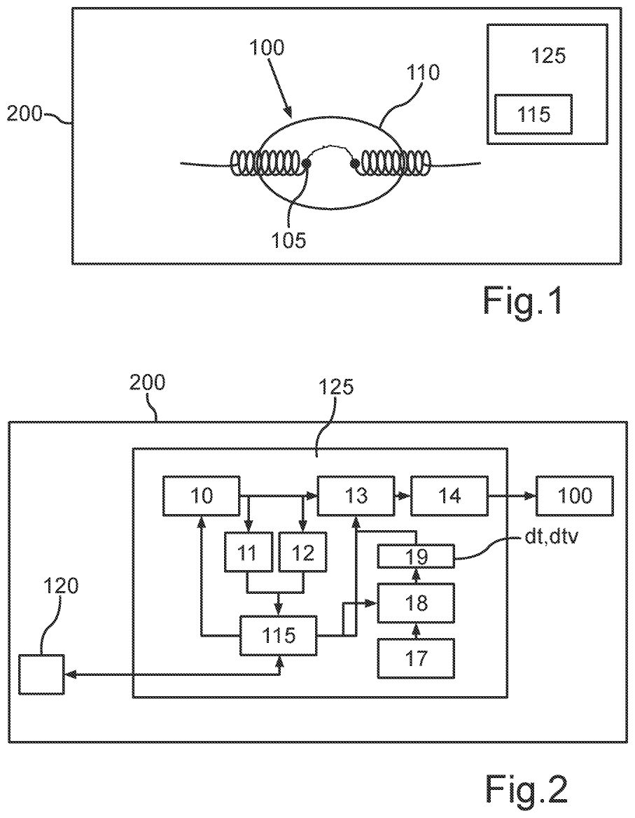

FIG. 1 a schematic illustration of a discharge lamp;

FIG. 2 a schematic operation scheme for a discharge lamp;

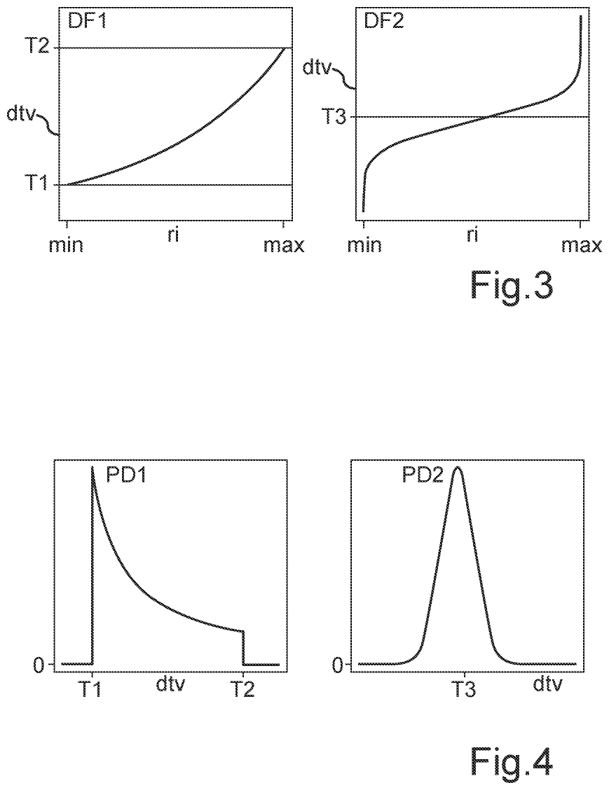

FIG. 3 examples of determining or calculating time span values from random numbers;

FIG. 4 predetermined probability density functions PD1 and PD2 corresponding to the inverse cumulative distribution functions DF1 and DF2 shown in FIG. 3 for calculating the time span values;

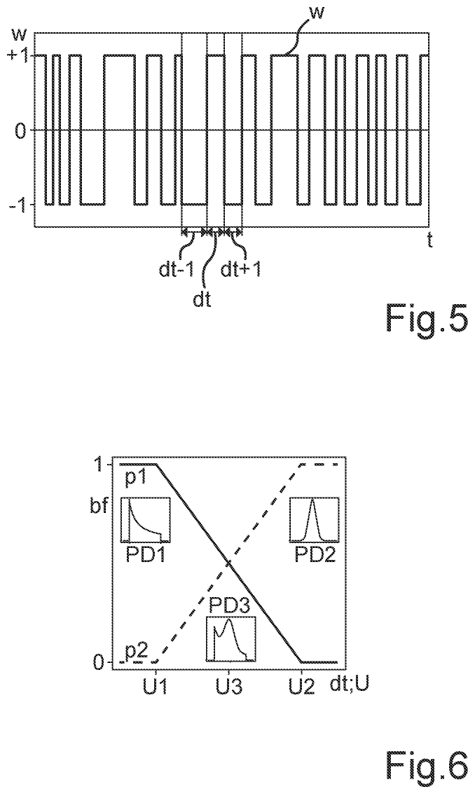

FIG. 5 an output current signal with pseudo-random sequence of several different time spans between commutations based on first distribution function according to FIG. 3;

FIG. 6 example of a superposition of two different probability density functions depending on the lamp voltage;

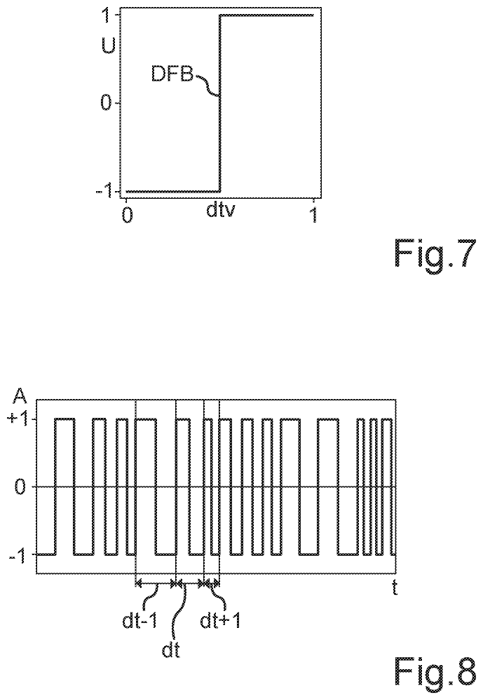

FIG. 7 example of a simple pattern or a building block for constructing a randomized current signal;

FIG. 8 example of an output current signal with a random sequence of patterns according to FIG. 7, wherein the duration of each pattern is based on the first distribution function according to FIG. 3.

In FIG. 1, a lighting apparatus 200 with a discharge lamp 100, a control unit 115 and ballast unit 125 as operation unit is shown. The discharge lamp 100 comprises an arc tube 110. Within the arc tube 110, a pair of electrode tips 105 is indicated. Between these two electrode tips 105, an arc discharge may appear. The discharge lamp 100 is able to emit light if a current A flows between the electrode tips 105. Within the arc tube 110, a noble gas, such as helium, argon, crypton, etc., or a metallic gas, such as mercury or natrium, may be present. If the discharge lamp 100 is operated with an alternating current AC at a single frequency, the discharge lamp 100 may suffer from uneven wear and tear. An important aspect of this invention is to avoid such drawbacks. This can be achieved by operating the discharge lamp 100 with a current signal w that is rather random instead of deterministic.

A random current signal w does not mean that the current signal w can take any possible value for the current flow A. For example, it is possible that the current signal of the lamp current is constructed as a continuous stream of time spans dt of direct current separated by the change of current direction or commutation. The amplitude of the direct current can be fixed according to the voltage of the lamp such that a prescribed nominal lamp power is maintained. The time span values dtv can be chosen randomly according to a prescribed distribution function DF. The distribution function DF may be limited or influenced by boundary conditions. Such boundary conditions may be a minimum or a maximum value for the time span values dtv. Furthermore, the distribution function DF may follow a pre-given distribution. Such a pre-given distribution may be a uniform distribution, a normal distribution or any other function. These functions may also consider physical lamp parameters 120 like the discharge lamp voltage U as well as environmental parameters 120 of the discharge lamp 100. This means that the distribution function DF may consider statistical parameters and/or physical parameters.

Statistical parameters may be considered by different pre-given distributions, whereas physical parameters may be considered by the lamp voltage U as well as other environmental parameters 120 of the discharge lamp 100. All these parameters may be considered by the distribution function DF. This means that a degree of randomness may be influenced. Since the time span values dtv are calculated by at least one random number ri, the current signal w may be determined randomly. The concrete definition of the distribution function DF may limit the degree of randomness, if necessary. A control unit 115 may gather and/or detect discharge lamp parameters and/or other environmental parameters of the discharge lamp 100 or lighting apparatus 200.

FIG. 2 shows an exemplary overview of several components of the lighting apparatus 200. The lighting apparatus 200 can comprise the operation unit 125 and a DC/DC converter 10. The current flow A can be detected by a current detector 11 and a voltage detector 12. The lamp operation unit 125 comprises a polarity switch 13. The control unit 115 can switch the polarity by the polarity switch 13. The operation unit 125 can be part of the lighting apparatus 200. The DC/DC converter 10 is used to control the current flow A according to a set value determined by the control unit 115. The set value can be determined based on measurements of the output voltage. Additionally, the control unit 115 can gather values for discharge lamp parameters 120 and/or environmental parameters 120. This means that the control unit 115 is able to measure and/or gather parameters concerning the current flow A and concerning environmental parameters 120 for the discharge lamp 100. An ignition device 14 can be used to create a starting voltage for the discharge lamp 100 at the start of the lamp operation.

A lamp operation unit 125 (ballast unit) may comprise a random number generator 17. The random number generator 17 may generate a set or stream of random numbers ri in a predetermined range. The predetermined range can be between the values 0 and 1. Several random numbers ri can be generated with a function following a uniform distribution. Usually, the random number generator 17 is based on a uniform probability. This means that the random numbers ri follow a uniform distribution. An adaption of the random number generator 17 is not necessary because physical and/or statistical influences may be considered by a distribution shaping unit 18. In the distribution shaping unit 18, these random numbers ri can be used to calculate values for the time spans dt. The distribution shaping unit 18 and/or the control unit 115 may calculate several time span values dtv from a distribution function DF or a corresponding distribution table.

In FIG. 3, two different distribution functions are exemplarily shown. The time span values dtv may be passed to a timer unit 19. The timer unit 19 may provide the several time span values dtv for the time spans dt. According to the time spans dt of the time unit 19, the control unit 115 can regulate or operate the polarity switch 13. Since the time span values dtv are influenced by one or more random numbers ri determined by the random number generator 17, the resulting time span values dtv may be randomly generated. This may lead to a randomized current signal w. The randomized current signal w expresses in the form of different time spans dt or durations between a change in polarity or between the commutations of the current flow A. The control unit 115 can switch the polarity or commutate the current flow A after every expiry of a corresponding time span dt. This means that the control unit 115 may commutate the current signal w at every instant of time according to the expiry of every time span dt.

The resulting output current signal w of the operational unit 125 may be a continuous stream of directly aligned periods of pieces of the current signal w, wherein each piece is represented by its time span dt with the duration of the time span value dtv. Thereby, these periods or pieces may have a different duration according to the several time span values dtv that may be calculated by the control unit 115 and/or the distribution shaping unit 18. According to the underlying distribution functions DF, the degree of randomness may be influenced and/or controlled. In an extreme situation, the distribution function DF may eliminate this random influence. Although this may be possible, such an operation is not intended.

In FIG. 3, two different distribution functions DF are shown. On the left side, a first distribution function DF1 and on the right side, a second distribution function DF2 is presented.

The first and second distribution functions DF1, DF2 may assign a time span value dtv to a random number ri. The random numbers ri may be within an interval that is defined by a minimum and a maximum value. The minimum value is indicated by “min”, the maximum value is indicated by “max”. By means of the distribution functions DF1 and DF2, values for the time spans dt or the duration for the time spans dt may be calculated by the random numbers ri. Instead of the distribution functions DF1 or DF2, a table or a lookup table may be used.

The first distribution function DF1 is an increasing function with increasing random numbers ri. All time span values dtv are within an interval defined by a first and second value T1 and T2 for the time span values dtv. The first value is called T1 and the second value is called T2.

The second distribution function DF2 shows another behavior. The second distribution function DF2 looks like a function similar to an inverse sign function, also known as arcus sinus. This means that the second distribution function DF2 may lead to other time span values dtv. This is due to the fact that the second distribution function DF2 is completely different to the first distribution function DF1. For example, it is possible that depending on the lamp voltage U, the control unit 115 chooses the first distribution function DF1 or the second distribution function DF2. For example, the second distribution function DF2 may be applied or used if the lamp voltage U is above a pre-given value, a threshold value, for the lamp voltage U. This example can be extended to any other parameter or combination of parameters. Such parameters may be temperature, pressure, inclination, and so on.

The distribution shaping unit 18 can be controlled by the control unit 115. This distribution shaping unit 18 may contain more than one or two distribution functions or distribution tables. The control unit 115 can determine which distribution function DF or table is used or applied based on quantities, such as the average lamp voltage U, the lamp voltage U depending on a direction of the current A or the dynamic behavior of the lamp voltage U during preceding time spans dt. This means that a selection of one distribution function DF can be depending on said discharge lamp parameters and/or environmental parameters 120 of the discharge lamp 100.

For example, the first distribution function DF1 may be applied if a growth of the electrode tips is desired. A selection of the first distribution function DF1 may be depending on a lamp voltage U that exceeds a pre-given first threshold value U1 for the voltage. The second distribution function DF2 may be used in order to facilitate a shrinking of the electrode tips 105. The second distribution function DF2 is preferably selected if the control voltage U lies below the first threshold value U1. This means that the first distribution function DF1 is known to allow a growth of the electrode tips 105 and the second distribution function DF2 is known to facilitate a shrinking of the electrode tips 105.

In FIG. 4, the probability density functions PD1 and PD2 corresponding to the distribution functions DF1 and DF2 are shown. The first distribution function DF1 is the inverse function of a cumulative of the first initial probability function PD1. The second distribution function DF2 is the inverse function of a cumulative of the second initial probability function PD2.

The probability density function PD1 may rely on a modified power law distribution. It may be expressed by the equations

t−D1=0; for t<T1,

t−D1=K/[t\hat{ }n]; for T1≤t≤T2,

t−D1=0; for t>T2.

t−D1 may be considered as a probability density as a function of possible values t for the time span values dtv. K is a normalization constant such that the integral value of t−D1 from t=0 to t=infinity results in unity. The value n is a constant characterizing the probability distribution, particularly the ratio of the probability density values at the boundaries T1 and T2.

The probability density function PD2 may rely on a normal or Gaussian distribution. It may be expressed by the equation

t−D2=1/(S*sqrt(π)*2)*exp(−½*((t−T3)/S)\hat{ }2

t−D2 may be considered as a probability density as a function of possible valued t for the time span values dtv. T3 is the mean or expectation value of the distribution. S is the width or standard deviation of the distribution.

By means of the probability distribution functions PD1, PD2 probability values like p1 or p2 for certain time span values can be modified. This means that predetermined boundary conditions may be realized by appropriate probability functions PD1 or PD2. This would lead to new modified first and second distribution functions DF1 and DF2. The functions DF1 and PD1 are preferably not independent, they relate to each other. For example according to the first probability function PD1 the probability for time span values dtv is zero for time span values larger than T2 and smaller than T1. Therefore, all time span values dtv lie between T1 and T2. The probability is zero concerning time span values dtv outside this interval.

The second probability distribution PD2 function PD2 shows a local maximum around the value T3. This adequately influenced the shape of the second distribution function DF2. This means that the distribution functions DF1 and DF2 are preferably a result of the probability distribution functions PD1 and PD2. In particular, the distribution function DF1 is an inverse function of an integral over the time of the probability distribution function PD1. The same is true for DF2 and PD2.

A status of the electrode tips 105 may be estimated or determined by the control voltage U that is used to operate the lighting apparatus 200 or discharge lamp 100. A control voltage U above the first threshold value U1 indicates that the first distribution function DF1 shall be applied, whereas a control voltage below the first threshold value U1 indicates that the second distribution function DF2 should be applied for the operation of the discharge lamp voltage 100.

FIG. 5 shows a current signal w according to different time spans dt and time span values dtv. The current signal w in FIG. 5 is based on the first distribution function DF1 and accordingly the probability density function PD1. The first probability distribution PD1 influences the distribution of the time span values dtv.

In FIG. 5 different values for the time spans are expressed by dt−1, dt and dt+1. dt−1 is the preceding time span of dt, whereas dt+1 is the following time span of dt. In case of FIG. 5 the duration of the time spans dt are between T1 and T2 according to the time span values dtv resulting from the first distribution function DF1. The first distribution function DF1 may be adapted or influenced by the first probability distribution function PD1. The same can be valid concerning DF2 and PD2. This first probability distribution PD1 influences the generation of time span values dtv in the distribution shaping unit 18. For example, the control unit 115 may apply the first probability distribution PD1 in order to influence the determining of the time span values dtv.

For example, the first probability distribution PD1 may be relevant for certain circumstances. For example, control unit 115 chooses the first probability distribution PD1 according to a lamp voltage value that is above or below a threshold value. It is also possible that the control unit 115 selects a second probability distribution PD2. In this case, the distribution of the calculated time span values dtv may follow a normal distribution that is represented by the second probability distribution PD2. Although the random number generator 17 provides uniform distributed random numbers ri, the distribution of the time span values dtv may be influenced by the first or second probability distribution PD1 or PD2.

It is also possible that the control unit 115 selects one of several probability distributions by means of an additional separate random number ri. In case of FIG. 5, one of the two shown probability distributions may be chosen by a second random number. In this case, each probability distribution has a probability of 50% to be selected by the control unit 115. In this case, a further random factor influences the calculation or determination of the time span values dtv.

The resulting distribution of calculated time span values dtv may be a smooth blend of all probability distributions according to assigned probabilities for the selection of the probability distributions. This means that another probability distribution can be pre-given or defined in order to select one of the several probability distributions. In particular, it is possible that the predetermined probability distribution for selecting the probability distributions is not uniform. The sum of such probability distribution for the selection is preferably 1 since a selection of a probability distribution may be necessary in order to operate the discharge lamp 100. An example of such selection of probability distributions is the mentioned selection between the first and second probability distribution PD1 and PD2 shown in FIG. 4. Depending on the lamp voltage U, the first probability distribution or the second probability distribution PD2 may be chosen or selected for determining the time span values dtv. It is possible to perform the process of selection for every time span dt.

In FIG. 6, an example of a third probability distribution PD3 is shown that is a result of a superposition of the first and second probability distribution PD1 and PD2. The superposition may be a linear superposition. In the example of FIG. 6, a blending factor bf is calculated in order to compute the third probability distribution PD3. The calculation of the blending factor bf preferably depends on the lamp voltage U. In this case, the first threshold value U1 and a second threshold value U2 are relevant for the computation of the blending factor bf. The blending factor bf depends on two variable probability factors p1 and p2. The first probability factor p1 represents the probability for the first probability distribution PD1. The second probability factor p2 represents the probability for the second probability distribution PD2. The first and second probability factors p1 and p2 depend on the lamp voltage U.

If the lamp voltage U is below the first threshold value U1, the first probability factor p1 is 1 and the second probability factor p2 is 0. If the lamp voltage U is larger than a second threshold value U2 concerning the lamp voltage, the second probability factor p2 is 1 and the first probability factor p1 is 0. Between the first and second threshold values U1, U2 concerning the lamp voltage U the blending factor bf is generated by a linear superposition of the first probability factor p1 and the second probability factor p2. At the third threshold value U3, the first and second probability factors are equal. The first probability factor p1 is defined according to the following equation 1.

p1=1−[U−1]/[U2−U1]; equation 1

The second probability factor p2 can be expressed by the following equation 2.

p2=[U−U1]/[U2−U1]; equation 2

It is also possible to use a non-linear superposition of the first and second probability distribution. In FIG. 6, the superimposed third probability distribution PD3 is shown above the value for the third threshold value U3 for the voltage U. It can be seen that PD3 is a mixture of PD1 and PD2. According to the example of FIG. 6, the degree of superposition is depending on the lamp voltage U of the discharge lamp 100. The ratio of the first probability distribution PD1 and second probability distribution PD2 for the superposition that leads to the third distribution PD3 may be calculated by the equations 1 and 2. The third distribution PD3 may represent the superposition of the first probability distribution PD1 and second probability distribution PD2.

A further variation or embodiment of this invention in shown by FIGS. 7 and 8. In this case, a segment pattern or a building block DFB may be used for creating a randomized current signal w. In FIG. 8, the output current A is shown, wherein the output current A is created by a building block DFB according to FIG. 7. The building block DFB of FIG. 7 consists of two segments or parts with equal length and opposite polarity. The building block DFB may follow a pre-given regimentation or rule. In case of FIG. 7, the rule would be to change the polarity in the middle of a time span dt. The rule or regimentation may further be depending on parameters, such as the lamp voltage U, and other lamp parameters 120 of the discharge lamp 100.

It may be possible that several building blocks DFB can be given and the current signal w may be determined randomly by a random combination of different building blocks DFB. In this case, a further random input to the current signal w is possible. The application of several different building blocks DFB may be seen as a special form of determining the several time span values dtv depending on the distribution function DF. The distribution function DF may be represented by the corresponding building blocks DFB. By the one or more random numbers ri, a certain building block DFB may be chosen or selected from several building blocks DFB. It is possible to assign different building blocks DFB to the different environmental or physical lamp parameters 120. The control unit 115 may select one or more building blocks out of the several building blocks depending on boundary conditions and/or by the at least one random number ri. Preferably, the building blocks DFB comprise a polarity switch so that several time span values dtv may be determined depending on the building blocks DFB as distribution function DF. If the control unit 115 executes the current flow A according to the current signal w derived from the building blocks DFB, a commutation of the current signal w or a current flow A appears.

A total duration of all building blocks DFB or each building block DFB may be determined randomly according to a prescribed distribution function DF. Further variation may be introduced by a random choice of the patterns or building blocks DFB from a pool of pre-given building blocks DFB.

Overall, with these methods, a randomness of the current flow A or the current signal w may be created and may help to smooth an interference with image sensors. An acoustical noise related to the current flow A, for example in inductors, may spread over a large spectral width and thereby less perceptible than noise emitted at singular frequencies. The use of the distribution function DF or related functions like the building blocks DFB allow to specify the duration of the time spans dt. This allows a level of control superior to using a simple frequency modulation or temporal multiplexing. At the same time, the random nature of the commutation pattern helps to avoid the appearance of frequency peaks in the current spectrum. This may help to reduce visible interference in recordings made using imaging sensors as any remaining artifacts will be randomly patterned in contrast to embodiments of prior art where artifacts are typically patterned according to heterodyne beat. Also, any acoustical noise related to the lamp current flow A, for instance caused by the current flow A through inductors, will be spread across a large frequency range and is thus considerably less audible. This may help to operate the discharge lamp 100 more efficiently and to increase the quality of the light emission of the discharge lamp 100 as well as its lifetime.

In general, this invention offers a method and a lighting apparatus 200 with a discharge lamp 100 that uses current signals w which are created or assembled by random influence. The random influence is ensured by a combination of the distribution function DF together with the random number(s). By means of the random number(s) ri values relevant for the current signal w are determined. Since this calculation depends on the random number(s) ri, a certain degree of randomness can be maintained. Nevertheless, the distribution function DF may contain boundary conditions so that a good balance between a deterministic control and randomness can be achieved. This may help to a better discharge lamp operation with respect to quality and/or lifetime.

### LIST OF REFERENCE SIGNS

200 lighting apparatus
100 discharge lamp
110 arc tube
105 electrode tip
10 DC/DC converter
11 current detector
12 voltage detector
13 polarity switch
14 ignition device
115 control unit
17 random number generator
18 distribution shaping unit
19 timer unit
125 operation unit
120 environmental parameters
100 discharge lamp
dt time span
dtv time span values
T1, T2, T3 first, second, third time value
DF1, DF2 first, second distribution function
DF distribution function
ri random number
A current, current flow
w current signal
PD1, PD2 first probability distribution, second
probability distribution
dt time span, time interval
min, max minimum and maximum value
DFB building block, pattern
U voltage
bf blending factor
p1, p2 first and second probability factor/value
U1, U2, U3 first, second and third threshold value for the voltage

1. A method for operating a discharge lamp by adapting a current signal by performing the following steps:
(a) defining and/or providing a distribution function for gathering several time span values that define several different time spans,
(b) determining the several time span values depending on the distribution function by one or more random numbers, and
(c) commutating the current signal at every instant of time according to an expiry of each of the several time spans.

2. The method according to claim 1, wherein the several time spans are arranged directly adjacent.

3. The method according to claim 1, wherein several distribution functions are used and for each time span value one of those distribution functions is selected according to a further random number.

4. The method according to claim 1, wherein step a), step b) and/or step c) are performed repeatedly.

5. The method according to claim 1, wherein the distribution function is defined depending on one or more discharge lamp parameters, in particular a lamp voltage, a power level of the discharge lamp, a position and orientation of the discharge lamp, a current flow through the discharge lamp, an abrasion degree of a pair of electrode tips and/or the voltage ratio of time spans of opposite polarity.

6. The method according to claim 5, wherein the distribution function is defined dynamically based on a measured quantity or several measured quantities that describe the discharge lamp parameter and/or the parameter of the pair of electrodes of the discharge lamp.

7. The method according to claim 5, wherein the defining of the distribution function is based on a dynamical behavior of an average lamp voltage, a dynamic behavior of the lamp voltage during each time span and/or a dynamical behavior of the current flow through the discharge lamp.

8. The method according to claim 5, wherein several distribution functions are given and the distribution function for determining the time span values is selected based on a threshold value concerning the discharge lamp voltage.

9. The method according to claim 5, wherein at least two different probability functions are given and the distribution function for determining the time span values is a superposition of the least two different probability functions, wherein the superposition is depending on the lamp voltage.

10. The method according to claim 5, wherein the distribution function is defined by a characteristic diagram of the discharge lamp voltage, in particular the distribution function is depending on a threshold value of the discharge lamp voltage.

11. The method according to claim 1, wherein for different types of discharge lamps and/or for different groups of discharge lamps a separate distribution function is defined.

12. The method according to claim 1, wherein the distribution function contains a boundary condition.

13. The method according to claim 12, wherein a probability value with regard to a corresponding predetermined time span value is defined by the boundary condition or several probability values with regard to corresponding predetermined several time span values are defined by the boundary condition, wherein in particular the probabilities of the several time span values are defined by a ratio to each other.

14. The method according to claim 12, wherein a maximum and a minimum value is defined by the boundary condition.

15. The method according to claim 1, wherein the distribution function is superposed with a predetermined function,
or one of several predetermined functions, wherein at least one of the several predetermined functions is selected by the at least one random number in order to determine the time span values.

16. The method according to claim 1, wherein distribution function is defined based on a lifetime of the discharge lamp.

17. The method according to claim 1, wherein the current signal is a wave-shaped signal, a square-wave signal or a mixture of wave-shaped and square-waved signal.

18. The method according to claim 1, wherein the distribution function is defined as a uniform distribution, a normal distribution, an exponential distribution, a power law distribution and/or an overlaid normal distribution.

19. A lighting apparatus comprising
a discharge lamp with an arc tube with a pair of electrodes,
a ballast unit for providing a current signal for the discharge lamp and
a control unit that is configured to
define and/or provide a distribution function for gathering several time span values that define several different time spans,
determine the several time span values depending on the distribution function by one or more random numbers, and
commutate the current signal at every instant of time according to an expiry of each of the several time spans.
